(19) United States
(12) Patent Application Publication
(10) Pub. No.: US 2009/0002592 A1
(43) Pub. Date: Jan. 1, 2009

(54) BACKLIGHT MODULE AND OPTICAL DISPLAY DEVICE HAVING THE SAME

(75) Inventors: Hung-Jen Ma, Hsinchu (TW); Chia-Tsao Wu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/955,343

(22) Filed: Dec. 12, 2007

(30) Foreign Application Priority Data
Jun. 29, 2007 (TW) 96123775

(51) Int. Cl. G02F 1/1333; F21V 7/04; F21V 7/00

(52) U.S. Cl. 349/56; 362/612; 362/620

(57) ABSTRACT

A backlight module including a light source, a light guide plate and a prism sheet is provided. The light source is arranged along a first direction. The light guide plate having a light incident surface, a light refraction surface and a light emission surface is disposed on one side of the light source. The light refraction surface has a plurality of grooves parallel to one another in a second direction. The prism sheet is disposed on the light emission surface of the light guide plate, and has a plurality of prism portions parallel to one another in a third direction and on a surface of the prism sheet facing the light emission surface. The second direction is substantially perpendicular to the third direction, and an acute angle formed between the first direction and the third direction is less than or equal to 7 degrees.

### CROSS-REFERENCE TO RELATED APPLICATION

This application claims the priority benefit of Taiwan application serial no. 96123775, filed on Jun. 29, 2007. The entirety of the above-mentioned patent application is hereby incorporated by reference herein and made a part of this specification.

### BACKGROUND OF THE INVENTION

1. Field of the Invention

The present invention relates to a backlight module, and more particularly to a backlight module capable of preventing the liquid crystal display (LCD) panel from generating moire phenomenon, while maintaining certain brightness.

2. Description of Related Art

In order to keep up with the pace of the current life style, the volumes of video or imaging devices are getting increasingly lighter and thinner. Though the conventional cathode ray tube display (CRT) has many advantages, due to the structure of the internal electron cavity, the CRT display has a large volume and occupies an excessive space, and the problem that the human eyes are possibly hurt due to the generated radiation also exists. Accordingly, flat panel displays, developed as the development of the optoelectronic technology and the semiconductor manufacturing technology, for example, optical display devices (liquid crystal displays), organic light emitting displays (OLEDs), or plasma display panel (PDPs), have gradually become the mainstream of displays.

Taking an optical display device as an example, it is mainly composed of a liquid crystal display (LCD) panel and a backlight module. The liquid crystal display (LCD) panel is generally formed by two transparent substrates and a liquid crystal layer sandwiched there-between, and the backlight module provides the surface light source required by the LCD panel to achieve the displaying effect. Additionally, a front polarizer and a rear polarizer are generally disposed on an upper surface and a lower surface of the LCD panel, such that the optical display device achieves the displaying effect. Additionally, in order to improve the brightness of the backlight module, two prism sheets are generally disposed between the LCD panel and the backlight module.

It should be noted that, after passing through the prism sheets and the LCD panel, the surface light source provided by the backlight module generally generates a plurality of moire parallel to one another and on the display area of the LCD panel, which may be observed by a user with naked eyes, thus affecting the displaying quality of the optical display device.

Therefore, currently, some manufacturers rotate the prism sheet to a certain angle, such that the lights are not interfered after passing through the prism sheet and the LCD panel, thus solving the problem of moire observed on the optical display device. However, when the prism sheet is rotated to a certain angle, the overall brightness of the backlight module is reduced adversely, thus the displaying quality of the optical display device is also affected.

### SUMMARY OF THE INVENTION

Accordingly, the present invention is directed to a backlight module applicable for an optical display device, which is capable of preventing the moire phenomenon generated on the liquid crystal display panel, without reducing the brightness of the backlight module, thus improving the displaying quality of the optical display device.

An embodiment of the present invention provides a backlight module, which includes a light source, a light guide plate, and a prism sheet. The light source is capable of emitting a light beam and is arranged along a first direction. The light guide plate has a light incident surface, a light refraction surface and a light emission surface, and is arranged at one side of the light source. The light beam is incident to the light guide plate through the light incident surface, and then scattered by the light refraction surface and emitted through the light emission surface. The light refraction surface has a plurality of grooves thereon parallel to one another in a second direction. The prism sheet is disposed on the light emission surface of the light guide plate, and has a plurality of prism portions parallel to one another in a third direction and the prism portions are on a surface facing the light emission surface. The second direction is substantially perpendicular to the third direction, and an acute angle formed between the first direction and the third direction is less than or equal to 7 degrees.

According to an embodiment, the present invention provides an optical display device, which includes a backlight module as that described above and a liquid crystal display panel disposed above the backlight module. The liquid crystal display panel includes a thin film transistor array substrate, a color filter substrate, and a liquid crystal layer. The liquid crystal layer is disposed between the thin film transistor array substrate and the color filter substrate.

According to the embodiments of the present invention, the backlight module applied in an optical display device makes the acute angle formed between the third direction, along which the prism portions extend, and the first direction, along which the light source extends, of less than 7 degrees by means of rotating the prism sheet, and meanwhile makes the second direction, along which the grooves of the light guide plate extend, be substantially perpendicular to the third direction by means of rotating the light guide plate. In this manner, not only the problem of moire observed on the liquid crystal display panel is solved, but also the backlight module maintains the required brightness.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are respectively an exploded perspective view and a side view of a backlight module according to an embodiment of the present invention.

FIG. 2 is a schematic top view and side view of a light guide plate and a prism sheet in FIGS. 1A and 1B.

FIG. 3 is a side view of an optical display device according to an embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

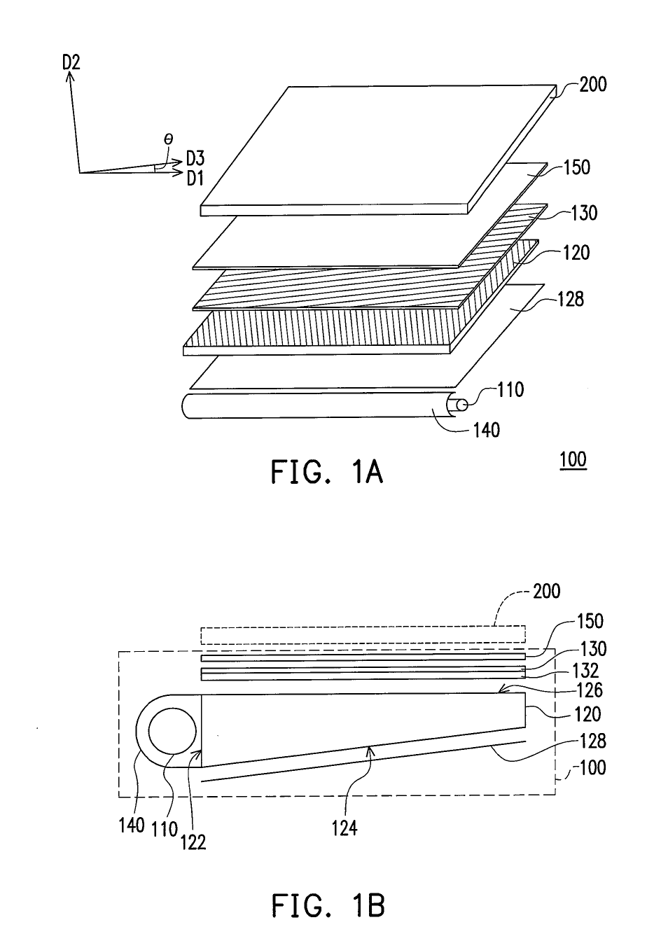

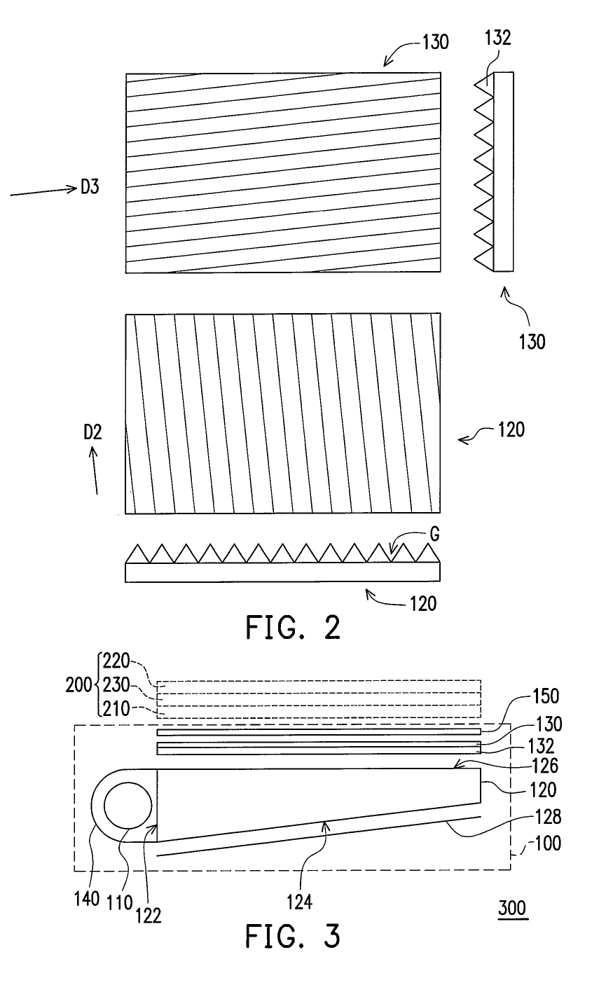

FIGS. 1A and 1B are respectively an exploded perspective view and a side view of a backlight module according to an embodiment of the present invention. FIG. 2 is a schematic top view and side view of a light guide plate and a prism sheet in FIGS. 1A and 1B. Referring to FIGS. 1A, 1B, and 2 together, according to the embodiments of the present invention, a backlight module 100 is adapted to an optical display device (not shown) and includes a light source 110, a light guide plate (LGP) 120, and a prism sheet 130. The light source 110 is capable of emitting a light beam and extends along a first direction D1. In an embodiment of the present invention, the light source 110 is, for example, a cold cathode fluorescent lamp (CCFL) capable of emitting white lights or a light emitting diode (LED) array. Additionally, the light source 110 is generally disposed in a reflector 140, so as to reflect the light beam into the LGP 120 through the reflector 140. The LGP 120 is disposed on one side of the light source 110 and has a light incident surface 122, a light refraction surface 124, and a light emission surface 126, and the light refraction surface 124 has a plurality of grooves G thereon parallel to one another along a second direction D2. The grooves G are generally V-shaped grooves. Additionally, a reflection film 128 is disposed below the light refraction surface 124 of the LGP 120. A part of the light beams emitted from the light source 110 are firstly reflected by the reflector 140 and incident to the LGP 120 through the light incident surface 122; the other part of the lights beams are directly incident to the LGP 120 through the light incident surface 122, then scattered by the grooves G of the light refraction surface 124 and reflected by the reflection film 128, and then the light beams are emitted through the light emission surface 126, so as to form a surface light source, which serves as the light source required by liquid crystal display (LCD) panel 200.

The prism sheet 130 is disposed on the light emission surface 126 of the LGP 120 and has a plurality of strip-shaped prism portions 132 parallel to one another along a third direction D3 and the prism portions 132 are on a surface facing the light emission surface 126. In order to prevent the moire from generating on the LCD panel 200, by rotating the prism sheet 130, an acute angle θ formed between the third direction D3 along which the prism portions extend and the first direction D1 along which the light source extends is less than 7 degrees. In this manner, the situation of generating moire on the LCD panel 200 is prevented. Additionally, in order to avoid the reduction of the brightness of the backlight module 100 due to the rotation of the prism sheet 130, the LGP 120 is also rotated together with the prism sheet 130, such that the second direction D2 along which the grooves G of the LGP 120 extend is substantially perpendicular to the third direction D3. In this manner, the backlight module 100 maintains the initial brightness, such that the problem in the conventional art that the brightness of the backlight module is reduced due to the rotation of the prism sheet is solved.

Additionally, at least one optical film 150 is selectively disposed on the light emission surface 126 of the LGP 120, for example, a diffusion film, a brightness enhancement film, or a combination thereof, so as to achieve desired optical effects. The types and numbers of the optical film 150 are not limited in the present invention.

In order to prove that the backlight module 100 according to the embodiments of the present invention can truly solve the problem of the moire observed on the LCD panel 200 and can maintain the initial brightness, the following experiments are carried out to the embodiments of the present invention, so as to prove that the backlight module can truly solve the problem of moire and the reduction of the brightness of the backlight module 100.

TABLE 1

| | SAMPLE NO | | |
|---|---|---|---|
| | A (Having moire) | B (Without moire) | C (Without moire) |
| | Prism Sheet | Prism Sheet | Prism Sheet |
| | 0 degrees | 7 degrees | 7 degrees |
| | LGP 0 degrees | LGP 0 degrees | LGP 7 degrees |
| Brightness | 3588 | 3139 | 3606 |
| Difference | 0% | −12.5% | 0.6% |
| of | | | |
| brightness | | | |

Referring to Table 1, according to the embodiments of the present invention, three groups of experiments A, B, and C are carried out, in which the experiments in Group A are performed without rotating the prism sheet 130, the experiments in Group B are performed through rotating the prism sheet 130 by 7 degrees but without rotating the LGP 120, and finally, the experiments in Group C are performed through rotating the prism sheet 130 by 7 degrees and followed by rotating the LGP 120 by 7 degrees. It can be known from Table 1 that, after rotating the prism sheet 130 by 7 degrees (in the experiments in Groups B and C), the problem of moire observed on the display panel 200 is truly solved. However, if the LGP 120 is not rotated together with the rotation of the prism sheet 130 (the experiments in Group B), the brightness is significantly reduced. When the LGP 120 is rotated by 7 degrees together with the rotation of the prism sheet 130 (the experiments in Group C), not only the problem of moire observed on the display panel 200 is solved, but also the it can maintain the initial brightness.

FIG. 3 is a side view of an optical display device according to an embodiment of the present invention. Referring to FIG. 3, an optical display device 300 includes, for example, a backlight module 100 shown in FIGS. 1A and 1B and a LCD panel 200. As the means for the backlight module 100 have already been described above, they will not be repeatedly described herein. The LCD panel 200 is disposed on the backlight module 100 and includes a thin film transistor array substrate 210, a color filter substrate 220, and a liquid crystal layer 230. The liquid crystal layer 230 is sandwiched between the thin film transistor array substrate 210 and the color filter substrate 220. The LCD panel 200 achieves the displaying effect through the surface light source provided by the backlight module 100.

To sum up, according to the embodiments of the present invention, the backlight module 100 and the optical display device 300 make the acute angle formed between the third direction D3, along which the prism portions 132 extend, and the first direction D1, along which the light source 110 extends, less than 7 degrees by means of rotating the prism sheet 130, and meanwhile makes the second direction D2, along which the grooves G of the LGP 120 extend, be substantially perpendicular to the third direction D3 by means of rotating the LGP 120. In this manner, not only the problem of moire observed on the LCD panel 200 is solved, but the backlight module 100 also maintains the initial brightness, such that the problem in the conventional art that the brightness of the backlight module is reduced due to the rotation of the prism sheet 130 is solved, thereby improving the quality of the optical display device 300.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, adapted to an optical display device, comprising:
a light source, for emitting a light beam, and extending along a first direction;
a light guide plate, disposed at one side of the light source, and having a light incident surface, a light refraction surface, and a light emission surface, wherein the light beam is incident to the light guide plate through the light incident surface, then scattered by the light refraction surface, and emitted through the light emission surface, and the light refraction surface has a plurality of grooves thereon parallel to one another in a second direction; and
a prism sheet, disposed on the light emission surface of the light guide plate, and having a plurality of prism portions parallel to one another in a third direction and on a surface facing the light emission surface, wherein the second direction is substantially perpendicular to the third direction, and an acute angle formed between the first direction and the third direction is less than or equal to 7 degrees.

2. The backlight module as claimed in claim 1, wherein the light source comprises a cold cathode fluorescent lamp (CCFL) or a light emitting diode (LED) array.

3. The backlight module as claimed in claim 1, wherein the grooves are V-shaped grooves.

4. The backlight module as claimed in claim 1, further comprising a reflector, disposed at one side of the light guide plate, wherein the light source is disposed between the light guide plate and the reflector.

5. The backlight module as claimed in claim 1, further comprising a reflection film, disposed below the light refraction surface of the light guide plate.

6. The backlight module as claimed in claim 1, further comprising at least an optical film, disposed above the prism sheet.

7. The backlight module as claimed in claim 6, wherein the optical film comprises a diffusion film, a brightness enhancement film, or a combination thereof.

8. An optical display device, comprising:
a backlight module, comprising:
a light source, for emitting a light beam, and extending along a first direction;
a light guide plate, disposed at one side of the light source, having a light incident surface, a light refraction surface, and a light emission surface, wherein the light is incident to the light guide plate through the light incident surface, then the light is scattered by the light refraction surface, and emitted through the light emission surface, and the light refraction surface has a plurality of grooves thereon parallel to one another in a second direction; and
a prism sheet, disposed on the light emission surface of the light guide plate, and having a plurality of prism portions parallel to one another in a third direction and on a surface facing the light emission surface, wherein the second direction is substantially perpendicular to the third direction, and an acute angle formed between the first direction and the third direction is less than or equal to 7 degrees; and
a liquid crystal display panel, disposed above the backlight module.

9. The optical display device as claimed in claim 8, wherein the light source comprises a cold cathode fluorescent lamp (CCFL) or a light emitting diode (LED) array.

10. The optical display device as claimed in claim 8, wherein the grooves are V-shaped grooves.

11. The optical display device as claimed in claim 8, further comprising a reflector, disposed at one side of the light guide plate, wherein the light source is disposed between the light guide plate and the reflector.

12. The optical display device as claimed in claim 8, further comprising a reflection film, disposed below the light refraction surface of the light guide plate.

13. The optical display device as claimed in claim 8, further comprising at least one optical film, disposed above the prism sheet.

14. The optical display device as claimed in claim 13, wherein the optical film comprises a diffusion film, a brightness enhancement film, or a combination thereof.

15. The optical display device as claimed in claim 8, wherein the liquid crystal display panel comprises:
a thin film transistor array substrate;
a color filter substrate; and
a liquid crystal layer, disposed between the thin film transistor array substrate and the color filter substrate.
